(19) United States
(12) Patent Application Publication
(10) Pub. No.: US 2011/0075190 A1
(43) Pub. Date: Mar. 31, 2011

(54) METHOD AND SYSTEM FOR ESTABLISHING PRINTER COMMUNICATION

(76) Inventors: Joseph A. Manico, Rochester, NY (US); David J. Cornell, Scottsville, NY (US)

(21) Appl. No.: 12/566,765

(22) Filed: Sep. 25, 2009

(51) Int. Cl. G06F 15/00

(52) U.S. Cl. 358/1.15

(57) ABSTRACT

A imaging device is provided having a transceiver adapted to send and receive wireless communication signals and a contact surface. A contact circuit is adapted to detect contact of imaging device with said contact surface. A controller is adapted to enable communication only between the imaging device and detected imaging device.

### FIELD OF THE INVENTION

The invention relates to wireless communication systems and in particular, to a method for establishing an ad hoc network between one or more imaging devices and a communication device.

### BACKGROUND OF THE INVENTION

Various communication systems and devices exist that permit the formation of a network of wireless communication devices. Cellular telephones, two-way pagers, and wireless personal digital assistants can be used to permit communications between members of a group. However, using such existing devices, it is often very difficult to establish, maintain, use and terminate an ad-hoc network.

For example, the user of a cellular telephone can create an ad hoc network by obtaining phone numbers for other cellular telephones and arranging for a three-way or conference call. However, such a network cannot be established rapidly. Further such a network requires that the permanent identification numbers that are associated with each phone be shared with others. This permits anyone who has access to the identification number to attempt to call the holder of the phone. Thus, many users of cellular telephones are reluctant to share their telephone numbers with others with whom they may have only an ad hoc need to communicate.

It is also known to provide video cameras and monitors that communicate in a wireless fashion using multiple channels and code encryption to reduce the possibility of signal confusion and unauthorized monitoring of the channel. For example, in JP10145637 what is shown is a video camera and monitor that are adapted to exchange video in a wireless fashion. Before installation of the camera, the camera and monitor are joined by a wire connector and identification codes are exchanged. The use of the wire connection to exchange codes eliminates the risk of interception of the codes that is associated with exchanging the codes wirelessly. This exchange of identification codes however, can be tedious to execute where multiple devices must be registered for mutual communication.

Alternatively, other types of communication devices such as the Talkabout (R) system sold by Motorola Corporation Schaumburg, Ill. provide simple access to one or more open communication channels. Any number of members can form a network on such a channel. Communications are encoded using one of a plurality of predefined codes. Each user in a network selects the same channel/code combination. Access to communications is restricted because each device has multiple communication channels with multiple codes that can be used. This makes it unlikely that a surreptitious listener will obtain the proper channel and code combination to listen to a particular communication. This method too can be inconvenient to execute because each member of the group must manually adjust for channel and code.

Other known wireless specifications and formats such as for example, the Bluetooth standard that is based upon Institute of Electrical and

Electronics Engineers standard 802.11b permit the formation of ad hoc networks. Bluetooth requires that a low-cost digital radio frequency transceiver chip be included in each communication device to be used in a network. Each device has , a unique 48-bit address. Using the unique 48-bit address, connections between communication devices can be quickly made. Such connections can be in a point-to-point or multi-point fashion. Bluetooth provides secure communications using a scheme of public and private encryption keys. Bluetooth devices have a communication range of about 10 meters. Each Bluetooth device uses an inquiry procedure to discover which other Bluetooth enabled communication devices are in range and to determine the addresses for the devices. The inquiry procedure involves a unit sending out inquiry packets. If another unit that is in range is in an appropriate state to receive the inquiry packets, the other unit will enter an inquiry response state and send an inquiry reply to the source. After the inquiry procedure has completed, a connection can be established using a paging procedure. It will be appreciated that using such a system requires a continual cycle of inquiries and responses. Such a system creates difficulties in that it allows for unwanted connections to be formed. These unwanted connections must be filtered out or otherwise sorted. It can be difficult for a novice user to separate desirable connections from undesirable connections.

Thus, what is needed is an apparatus and a method for establishing an ad hoc secure connection in a rapid and effective fashion. There is a further need for an apparatus and method that permits a user to privately communicate between a communication device and an imaging device in a simple and easy to understand manner. Additionally for legacy imaging devices that are not wirelessly enabled there remains a need to provide a means to wirelessly transmit standard file types in a secure fashion to these devices.

### SUMMARY OF THE INVENTION

A imaging device is provided having a transceiver adapted to send and receive wireless communication signals and an imaging device having a contact surface, such as a printer. A controller is adapted to enable communication with the imaging devices. Each device has a transceiver adapted to send and receive information using radio frequency signals said transceiver having an address. It is an object of the present invention is to provide a communication means combination that prevents the interception and unauthorized use of wirelessly transmitted standard file types.

In a further aspect what is provided is a method for forming a wireless communication with at least one imaging device that does not have a built-in wireless communication means and contact surface. In accordance with the method, the imaging device is provided with an adapter including a contact surface and wireless communication means to convert an imaging device to enable it to receive wirelessly transmitted standard file types.

### BRIEF DESCRIPTION OF THE DRAWINGS

FIG. 1 shows a communication and an imaging device in accordance with the present invention.

FIG. 2 shows a block diagram of a method in accordance with the present invention.

FIG. 3 shows an adapter that enables a touch surface feature, an usb converter plugged into a usb port of a imaging device.

FIG. 4 shows an imaging device with an usb converter connected and a communication device.

FIG. 5 shows an adaptor in accordance in with the present invention.

FIG. 6 shows a printer timer in accordance with the present invention.

### DETAILED DESCRIPTION OF THE INVENTION

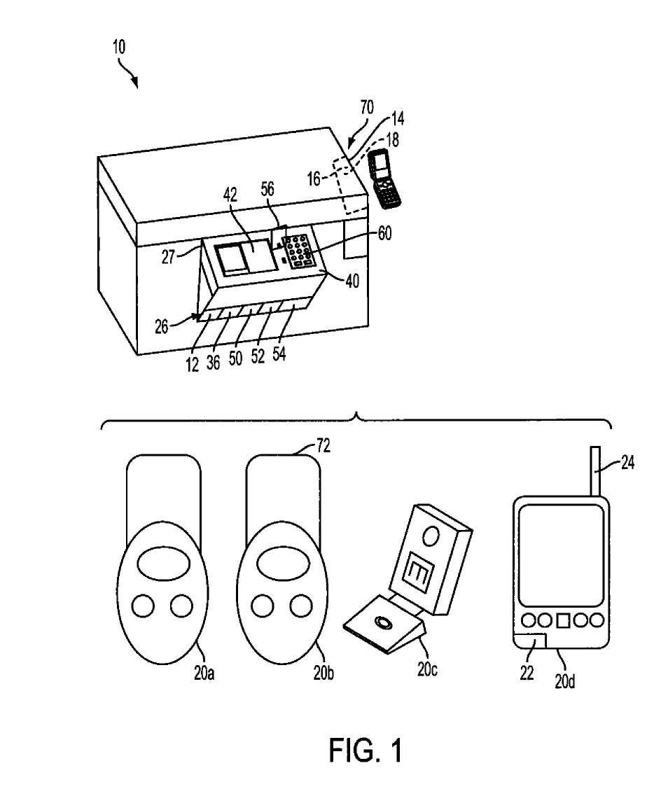

Turning now to FIG. 1, a block diagram of a simple embodiment of a imaging device system 10 is shown including a transceiver 12 adapted to send and receive wireless memory storage signals, a contact surface 14, a contact circuit 16 adapted to detect contact of a imaging device with said contact surface, and a sensor 18, which is in communication with the transceiver and the contact circuit, to receive a confirmation signal in response to contact with the imaging device indicating a compatible imaging device that will communicate with the imaging device. Details of the communication circuits are contained in a patent assigned to the applicant, entitled: “Method and System for establishing a Communication network”, U.S. Pat. No. 7,027,836 which is hereby incorporated by reference and discussed below in some detail.

In this embodiment, a plurality of like communication devices 20a-20n are provided that may communicate with the imaging device, shown here as a printer system 10. Each of the communication devices 20a-20n has a radio transceiver 22 and antenna 24. Radio transceiver 22 is adapted to transmit and receive radio frequency signals carrying digital data containing text, audio and video communications. In one useful embodiment, radio transceiver 22 is adapted to communicate using the high rate consumer wireless communication standard defined in Institute of Electrical and Electronic Engineers standard IEEE 802.15.3. In other embodiment the radio transceiver 22, can be adapted to communicate using the standards set forth in Institute of Electrical and Electronic Engineers standard IEEE 802.11b. Alternatively, radio transceiver 22 can employ any useful radio frequency communication scheme to send and receive data. Radio transceiver 22 can be adapted to transmit communication signals directly to others of communication devices 20a-20n. Alternatively, radio transceiver 22 can transmit signals to other imaging device devices by way of a separate intermediary communication site such as, for example, a cellular tower, satellite, wireless repeater, to the imaging device devices. For example, when the imaging device is wireless and includes a controller adapted to enable selective communication or even when the imaging device of claim 1 is not wireless and has an adaptor.

The radio transceiver 12 is similarly adapted to receive digital radio frequency signals from other devices. The digital radio frequency data is converted into digital data. The digital data is transferred to a controller 26 and converted into digital data.

Each one of communication devices 20a-20n can also have a controller. Controller 26 can comprise, for example, a general-purpose programmable microprocessor such as a Pentium microprocessor sold by Intel Corp. of San Jose, Calif., a microcontroller, or other similar control device adapted to control the operation of the imaging device 10 in which it is installed. In the embodiment shown, controller 26 is adapted to prepare data representing the content of communications to convey the data to transceiver and to cause the transceiver to transmit data. In addition, controller 26 is adapted to receive signals containing data from radio transceiver 22 and to process this data for use as described herein. Further each controller 26 controls the operation of the imaging device in which it is installed.

Wireless imaging devices can include devices such as printers, digital photo frames, and kiosks have become common. Due to the personal nature of consumer photographs and documents there is potential for abuse if these wirelessly transmitted files were intercepted by unauthorized users. Wireless imaging devices today can readily accept and print, display, upload, and/or store standard file types such as jpg, .tif, .pdf, .bmp, .html, .txt, without the requirement of providing drivers to the source imaging device. However, since these are standard file types that can be wirelessly transmitted the chance for interception and abuse by unauthorized users is increased. In addition since many imaging devices today include USB connectors, are not wireless enabled, and do not include contact surfaces to enable communications. The contact between contact surfaces establishes the encryption key between devices and also, to protect the integrity and authenticity of a message; a verification of a message authentication code (MAC) or a digital signature can be also exchanged to insure the security of the transmission.

Digital data representing the image device or printer, in this case, can also be provided to transceiver 12. Transceiver 12 converts the digital data into a digital radio frequency signal which is transmitted, such as with an antenna 27.

The transceiver 12 can also receives digital radio frequency signals from other of communication devices 20a-20n containing digital video data by way of antenna 24. The digital radio frequency data is converted into digital data. The digital data is transferred to controller 26 and converted into digital image data. The digital image data is transferred to display driver 40 and converted into images that are viewable on a display 42.

The imaging device can also include an audio system 50 that is adapted to capture and generate audio signals. In the embodiment shown, sound input is entered by way of microphone 52. Microphone 52 converts acoustical energy from the sound input into an electronic signal. This electronic signal is transmitted to A/D converter 54 that renders digital signals representing the sound. Controller 26 receives the digital signals representing the sound. Controller 26 processes these signals for storage in memory 36 or for use by radio transceiver 22.

In one embodiment radio frequency signals containing audio data are received by a radio transceiver 22. The radio transceiver 22 extracts digital data from radio frequency signals and provides this digital data to controller 26. As is described in greater detail in U.S. Pat. No. 7,027,836, controller 26 processes this data if necessary and provides a stream of digital audio data to A/D converter. The A/D converter 54 converts the data into an analog signal that is provided to a speaker 56 which in turn converts the analog signal into acoustical energy.

The imaging device 10 also has a user interface 60 that permits a user to encode numbers, text, and other forms of communication into electronic signals that are transmitted to controller 26. Controller 26 converts these electronic signals into digital data which can then be used to control the operation of the communication device, transmitted using the transceiver 12, stored in memory 36 and/or displayed on display driver 40 and/or 42.

Both the imaging device 10 and communication devices 20a-20n can have a contact detection system 70 including the imaging device contact surface 14 and the contact circuit 16. Each contact circuit 16 registers contact between the contact surface 14 of one of communication devices 20a-20n and the contact surface 72 of at least one other one of communication devices 20a-20n. When such contact is registered, the contact circuit 16 transmits a signal to its respective controller 26 indicating that such contact has been made. Each controller 26 then defines at least one mode of operation in which the processor communicates only with the set of communication devices 20a-20n with which the contact surface 72 has had contact. A user of the imaging device 10 or the communication device 20a can select this ad hoc network mode of communication using for example, user interface 60. User interface 60 comprises any known transducer for converting a user action into a signal that can be transmitted to controller 26. Examples of such a transducer include a switch, dial, stylus, mouse, joy stick, potentiometer, visible or non-visible light sensor or imager. User interface 60 can also have transducers that convert instructions into signals that can be interpreted by controller 26. User interface 60 can be combined with display 42 in the form of a touch screen or like device.

Contact circuit 16 can detect contact between a contact surface 14 to which it is connected and another contact surface of another device in a variety of ways. For example, where contact surface 14 and the other contact surface are electrically conductive, each contact circuit 16 can cause an electro-magnetic field to form on contact surface 14. When contact surface 14 is in contact with another contact surface, the electromagnetic fields combine. By monitoring the intensity, waveform, or signal content on each contact surface 14 each contact circuit 46 can detect when contact surface 14 is in contact with another contact surface. Other electro-magnetic methods for detecting contact can be used. For example, contact between two contact surfaces can be detected by noting variations in capacitance, electrostatic charge, and/or inductance at the contact surface. Electro-mechanical structures can also be used to register contact between two contact surfaces, such as vibrational, sonic or ultra sonic signal generators and detectors. Electro-optical detection structures can also be used, for example, when a contact surface 14 of, for example, communication device 20 is brought into contact with the contact surface 14 of the imaging device 10, the contact surfaces can be mechanically moved, deflected and/or otherwise mechanically changed. In this example, contact circuit 16 determines these changes and causes a particular light to emit. Contact circuit 16 detects light of the type emitted in response to contact and determines that contact has been made with another imaging device.

In one embodiment, a network identification signal is used to regulate communication between contacted imaging device devices. In this embodiment, when contact is registered between the contact circuit of the communication device 20 and the imaging device having a contact surface 14 in communication with the controller 26, the controller 26 of the imaging device determines a network identification signal that is used to designate communications that are intended for exchange between imaging device and other devices, even another imaging device. The network identification signal can comprise any mutually agreed upon signal. Conveniently the user identification signal can comprise or be derived from user identifications such as a user name or user identification image. When the user of another imaging device that, for example, wishes to communicate with the user of imaging device, the user places imaging device in the ad hoc network communication mode. The user of imaging device then captures data, voice, or a video signal, which is processed by controller 26 and converted into a signal that is transmitted to transceiver 12. This signal includes the network identification signal. The signal received by transceiver 12 of imaging device is then converted into a broadcast signal and transmitted using antenna 27 of imaging device.

The imaging device 10 can have a controller 26 that ignores communications that are transmitted without a network identification signal. Alternatively, imaging device can have a controller 26 that is operative in a mode that renders output based on the communications that are transmitted with and without a network identification signal. In the embodiment shown, imaging device has a controller 26 that is selectively operable in both the mode of ignoring communications that are transmitted with a network identification signal and the mode of rendering an output based on communications that are transmitted without a network identification signal. In another embodiment, the network identification signal can also be used as an encryption code to prevent surreptitious interception of communications transmitted using the network identification signal.

In another other embodiment, imaging devices are adapted to communicate using a wireless local area network communication scheme such as Bluetooth. As is noted above, using Bluetooth each transceiver 12 has a unique 48-bit address. Connections between individual devices are formed using the 48-bit address. Ad-hoc networks can be formed between sets of individual devices by compiling a list of all addresses and limiting networked communications to the devices on the list. As is also noted above, each Bluetooth enabled device continually scans all of the devices within its communication range to obtain addresses for potential use in future communications. When used at an event such as a baseball game or soccer game, with thousands of fans located in relatively close proximity, this approach could potentially garner hundreds of addresses from other devices that are within range. Sorting through the list of available devices to define an address list becomes particularly difficult under such circumstances.

In this embodiment, the set of imaging device to be included in the ad hoc network are identified on the basis of registered contact between the imaging devices. When each of imaging devices registers contact with another imaging device, controller 26 of each imaging device adds the address of the other imaging device to a list of addresses. Ad hoc communications are enabled by limiting distribution of all communication using the ad hoc network to those devices whose 48-bit address is contained within the distribution list.

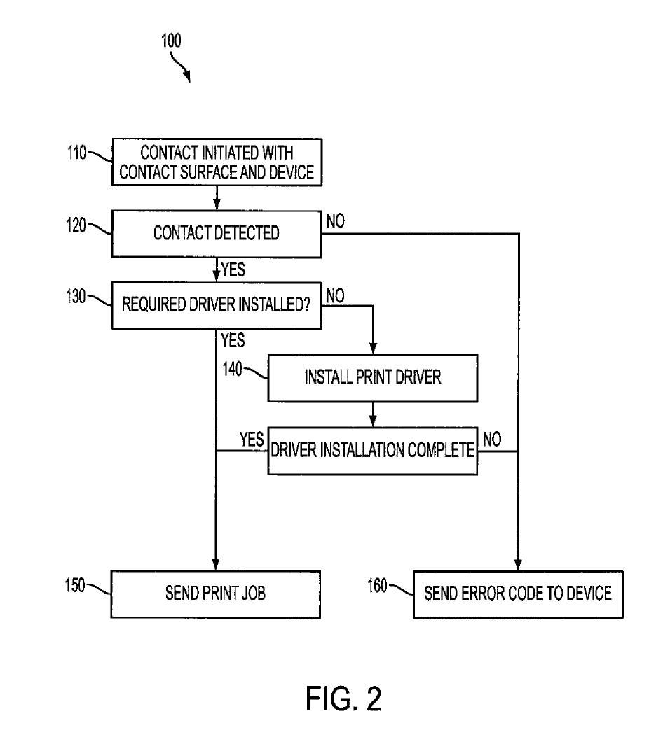

FIG. 2 shows a block diagram of one embodiment of a method for establishing an ad hoc communication network with the imaging device 10 to initiate a driver 100. In a first step, contact is initiated with the contact of a contact surface in the imaging device 10 and another surface of one or more of another imaging device and/or a communication device 20 (step 110). There are various ways that this can be done as described in detail above. If a the communication device 20 is, for example, incorporated into a cellular telephone or in the form of a personal digital assistant, these can be used to contact the surface of the imaging device, such as a printer surface. When contact is detected (120) then the controller 26 determines if a driver is required (130) and installs it (140) if it is needed and then if it is not installed states so (145). When the installation is complete the print job can be sent (150) or an error code sent (160) to the display 42. Many types of communication devices are capable of operating in a conventional mode of communications associated with the device such as using, for example, normal cellular telephone technology in the case of communication device and a mode for communication using PDA type communications in the case of communication device. These communication devices are also capable of operating in a mode of communication using an ad hoc network.

The imaging device can also be personalized. This can be done in various ways. In one embodiment the imaging device provides a welcome message and then provides an instruction message indicating that the personalization process is to be performed. Personalization is performed by capturing an image of the user of imaging device. A sequence of messages is presented to the user to indicate the countdown sequence before the image of the user will be captured. As the countdown begins, a preview image of the user is captured and presented under the sequence of messages so that the user can properly arrange user identification image to be used to represent the user. This image of course does not need to be an image of the user. Instead, the image can be an image of something representative of the user such as a favored article of clothing or favored photographic subject. Alternatively, a user can enter other personalization items such as a name, symbol, or other visible marking to represent the user of the device. In another alternative, a user identification image or symbol can be obtained from an external source or device such as an external camera system, a ring or other type of personal article having a memory capable of providing an identification signal and/or any other form of electronic memory such as a compact flash card or electronic memory. As will be described in greater detail below, the personalization step can also include entering a user profile.

This user profile can also be determined in advance of the personalization step and stored in memory. The user profile information can then be extracted from memory. In another embodiment, the personalization step can be omitted. Where this is done, default profile information can be used with each communication providing a unique identifier. In any embodiment, the controller 26 can be adapted to modify the user profile based upon the user's actual usage of the device to adapt the user profile so that the imaging device matches actual usage patterns.

The imaging device system 10 can be used to communicate using any number of forms of communication including but not limited to video still picture, text messaging, audio and/or icon or symbolic messaging. For example, files of recorded data such as recorded video files and text files can also be exchanged. In certain embodiments, gaming instructions, actions and other data can be exchanged. A user can use text messaging to vote or otherwise determine possible joint activities, meeting times and/or other matters requiring mutual agreement. For example, someone could send a message asking “Is anyone else hungry for pizza?” User interface 60 can incorporate, for example, a yes/no button that can be used to respond to such inquiries in a rapid and efficient fashion. Where this is done, controller 26 can be adapted to cause video display 42 to present a running count of the responses.

Once established, the ad hoc network can he used as is generally described above to share video, still images, icons, text, symbols and audio messages.

After its useful life, the ad hoc network is terminated. The ad hoc network can terminate at the request of a user of one of the imaging device, at the request of the majority of users, at a predetermined time, or at the end of an event or sequence of events. The conditions giving rise to termination of the ad hoc network can be defined using profiles or by manual control. The ad hoc network can be permanently terminated or it can be temporarily terminated and later re-established. Where the ad hoc network is permanently terminated, information regarding the ad hoc network and its participants will be erased or otherwise discarded by each of the imaging device involved in the network e.g. imaging device and/or any other communication nodes. Where the ad hoc network is temporarily disabled, the network can be re-enabled to permit communications between members of the group. After such communications, the network can again be terminated temporarily. Typically, at least one of the imaging devices in the ad hoc network can record information regarding the ad hoc network. This information is stored for example in one of the imaging device, stored by a supplier of rental imaging device, or stored by another service provider such as a telecommunications company, service provider, or other governmental, commercial or non-governmental organization.

Communications that are exchanged using the ad hoc network can also be recorded at the discretion of one or more the members of the ad hoc network. This can be done for example, for the purposes of providing a record of communications made using the network that can be incorporated into an output product for example in a scrapbook, commemorative video presentation or program or audio transcript. In the event that for example, police personnel arrive at a fire scene and establish an ad hoc communication, the fire personnel who later arrive at the scene enjoy the ad hoc network can review the communications that the police personnel have already had regarding the circumstances and can be in a better position to determine how to respond to the situation without causing the police personnel to repeat the communications. Such stored communications can also be used by accessed by users who join or rejoin an ad hoc network. This is particularly useful in situations where one or more members of the network cannot monitor communications because of distractions, loss of signal, equipment failure or for other reasons.

The network can be terminated at the end of the event or it can be terminated by user selection. In the case of user 2 and user 3 who have rented the device, termination of the network causes user preferences to be erased thus ensuring the privacy of the previous user when the device is next rented. If the network has not been terminated when the device is returned the rental counter, the rental person terminates the network. Upon leaving the event location, any additional features and any limitations that are placed upon personally owned devices such as imaging device by the event are removed. Upon termination of the network, saved and other communication can be stored, shared or incorporated into an output.

Where multiple communication networks are enabled, user interface 60 can include a channel selector allowing the user to conveniently select between networks. The selector can be a job dial or other convenient indicator. Preferably, where multiple networks are enabled, the imaging device will display images of the user identification images or user identification of the members of the network to provide visual assurance as to the recipients of communications transmitted by the imaging device.

In various embodiments described above, imaging devices have been shown as comprising or taking the form of existing imaging devices such as personal digital assistants and cellular telephone. Such devices currently have a predefined set of functions and communicate in a well-established fashion. As is noted above, devices of this type can be adapted to operate in a second mode of operation for communication using the ad hoc network. Various components of such devices can be used to support communication in both modes. For example, a conventional cellular telephone antenna can be used as a contact surface, or a conventional transceiver adapted for use in cellular telephone communications can be adapted to operate in a mode wherein it permits detection of contact between a telephone antenna and an imaging device having a contact surface of another device. User interface 60 can be used to instruct controller 26 of an imaging device as to which mode of operation is to be used.

In addition, various devices such as cellular telephones and personal digital assistants such as the Visor personal digital assistant sold by Handspring Corp., Mountain View, Calif., U.S.A. are adapted with modular input ports that permit modules that add functionality to the device to be easily added to and removed from the device. An imaging device as described herein can comprise any arrangement of an existing device such as a Visor and a modular attachment providing components or software necessary to adapt the existing device to operate in the manner described herein.

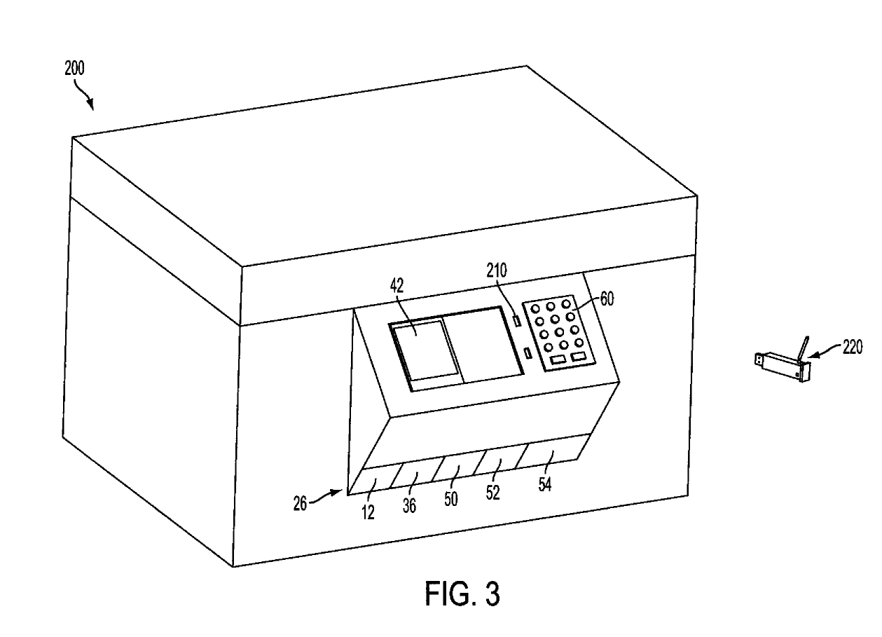

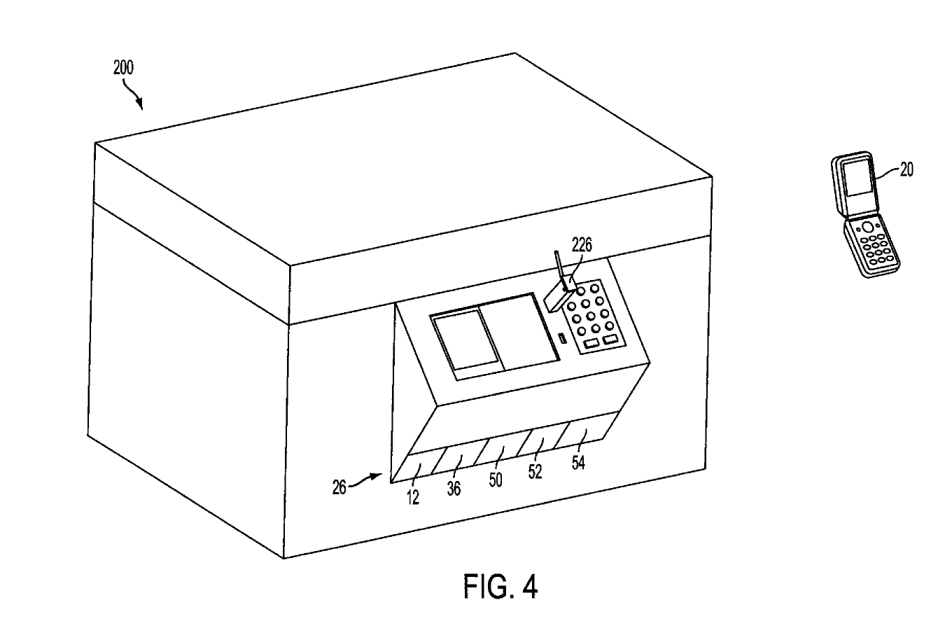

FIG. 3 shows a legacy imaging device that does not have a built-in wireless transmitter, contact surface, or contact detection system. The legacy printer 200 is shown in FIG. 3 with an adapter port 210, which can be a standard USB type port, capable of accepting an adapter 220 that has wireless capabilities, such as a wireless transceiver, a contact surface, and contact detection system. FIG. 4 shows the adapter engaged and a communication device near the imaging device. When the communication device contacts the contact surface 226 the contact detection system inside the adapter, responds as described above and enables the legacy printer to perform as a wireless imaging device, for example a wireless printer.

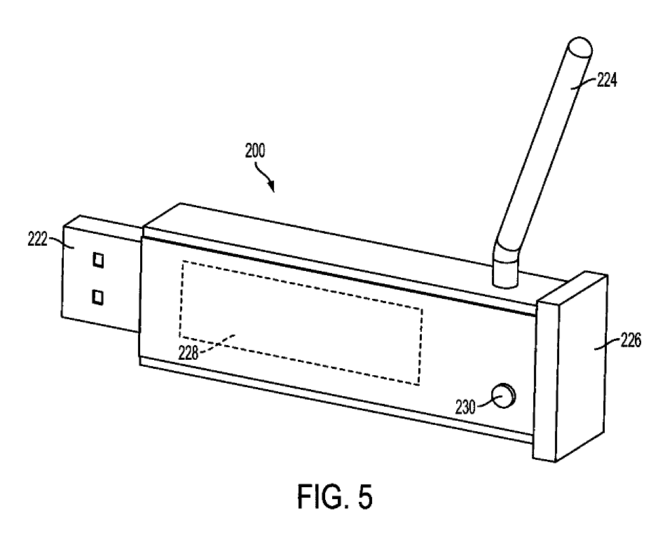

FIG. 5 is a detailed view of the adapter 220, including adapter connector 222 for interfacing an adapter port 210, antenna 224 for sending and receiving wireless signals, and contact surface 226. Contact detection system 228 operates as described above and is located within adaptor 220. In addition optional indicator light 230 in included on adapter 220 to indicate the operational status of the adapter.

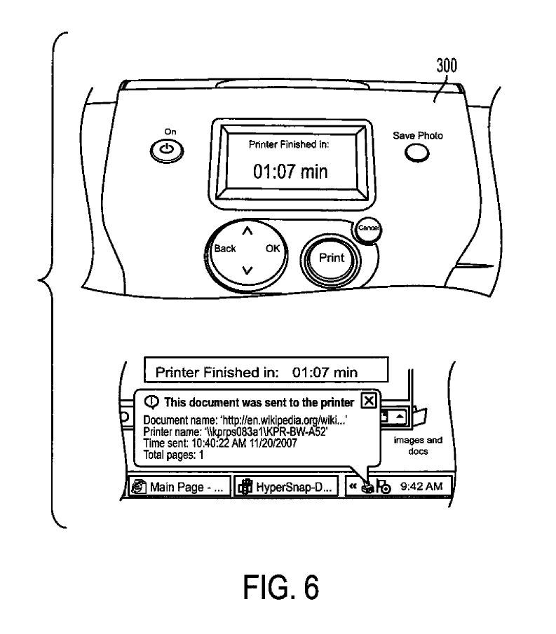

In yet another embodiment the imaging device can communicate an estimated printing time as shown in FIG. 6. This embodiment can supply an estimated completion time for when the print job is complete with a visual pop-up or audible signal on the user workstation in one or more imaging device 10. Other communication means, such as the communication devices 20, may also be used. These include, as discussed above, a cell phone, email, IM, pager signal etc, anything that can communicate the information. Other useful information that may be communicated to the users at the time they submit a print job may include important printer status such as media low, paper jam, toner low, error codes, etc. letting the user know that action needs to be taken in order for their job to be completed.

In this embodiment a “Timer” 300 is displayed on the printer monitor, such as a LCD, that reads out how long until your print/job will be finished. Often when you send a print to a printer that does not see a lot of traffic you walk up only to find the readout displaying “Engine Warming” or “Printer Calibrating”. This will now tell a user what is really wanted, that is when the print will be done and if not there how long the user should wait or rather come back in so many minutes. The timer could also be used to give an estimate of how long a large job will take and other print related information and it can be displayed on the printer or on a synched communication device 20 or even another imaging device. In one example, when the “sent to printer” balloon pops up the “Time to Completion” could also be displayed by getting feedback from the printer. Feedback could consider things such as: other jobs in queue, engine warming, printer calibrating, number of copies requested, print speed due to quality requested.

The invention has been described in detail with particular reference to certain preferred embodiments thereof, but it will be understood that variations and modifications can be effected within the spirit and scope of the invention.

What is claimed is:

1. An imaging device comprising:
a transceiver adapted to send and receive wireless memory storage signals;
a contact surface of imaging device;
a contact circuit adapted to detect contact of a communication device with said contact surface;
and a sensor to receive a confirmation signal in response to contact with the imaging device indicating a compatible communication device that will communicate with the imaging device.

2. The imaging device of claim 1 wherein the imaging device is wireless and further includes a controller adapted to enable selective communication.

3. The imaging device of claim 1 wherein the imaging device has an adaptor.

4. The imaging device of claim 1 wherein the compatible imaging device system has a print timer.

5. The imaging device of claim 1 wherein the compatible imaging device system has capability to accept one of the image type and receiver type.

6. The imaging device of claim 1 further comprising a security enabled system including an electronic pass system that uses a passcode.

7. The claim of claim 6 where in the passcode is a signal in response to a detected physical characteristic.

8. The imaging device of claim 1 wherein the contact surface is electrically conductive and the contact circuit is adapted to detect an electrical connection between the contact surface and an electrically conductive contact surface of the other communication devices.

9. The imaging device of claim 1, wherein said transceiver is operable in a contact registration mode wherein the transceiver is adapted to compromise the contact circuit.

10. The imaging device of claim 1, wherein the controller is adapted to receive identification codes from each detected communication devices.

11. The imaging device of claim 9 wherein each identification code has identification code sharing privilege associated therewith and said controller is adapted to share the identification codes of other communication devices only in accordance with the identification code sharing privileges.

12. The imaging device of claim 1, wherein the contact surface comprises an antenna.

13. The imaging device of claim 1 further comprising a channel selector wherein the controller is adapted to associate detected communication devices in groups with each group associated with a channel.

14. The printer of claim 13, wherein the controller is adapted to detect the position of the channel selector and to communicate with groups of detected communication devices associated with the channel indicated by a position of the channel selector.

15. A method for forming a connection between at least a communication device and a imaging device each having a contact surface, the method comprising the steps of; moving the contact surface of the communication device into contact with the contact surface of the imaging device in communication with a transceiver adapted to send and receive wireless memory storage signals; registering contact between the contact surfaces and sending a confirmation signal; and checking for imaging device compatibility for the communication device by receiving the signal indicating if the required imaging device drivers are installed in the communication device.

16. The method of claim 15, further comprising installing additional imaging device drivers if necessary based on the signal.

17. The method of claim 15, further comprising determining a user identification signal and the step of limiting memory storage in at least one mode to memory storage between contacted devices comprises only sending and receiving memory storages having the user identification signal further comprising the steps of entering a sharing profile into a first imaging device and using the sharing profile to limit the distribution of the user identification signal between a detected imaging device and the communication device that contacted the detected imaging device without contacting other communication devices.

18. The method of claim 15, the method further comprising communicating with a contact circuit adapted to detect contact of a imaging device with said contact surface; and a controller adapted to enable communication only between the imaging device and detected communication devices.

19. The method of claim 15 further comprising accessing a processor in the imaging device to estimate print job timing.

20. The method of claim 14 further comprising using a passcode to restrict access to the transmitter.

21. A printing system comprising: at least two printers and a communication device, each printer having, a transceiver adapted to send and receive information using radio frequency signals said transceiver having an address; a print engine to print images; a display adapted to display images; a contact surface; a contact circuit adapted to detect temporary physical contact between the contact surface of one of said printers and contact surface of a detected communication device; and a controller adapted to determine an address list containing the address of each transceiver of said detected imaging device, wherein each controller is operable for communicating only with imaging devices having an address on the address list after the detected temporary contact.

22. An imaging device adapter comprising:
an imaging device connector;
a transceiver adapted to send and receive wireless memory storage signals;
an antenna for sending and receiving wireless signals a contact surface of the adapter;
a contact circuit adapted to detect contact of a communication device with said contact surface; and
a sensor to receive a confirmation signal in response to contact with the imaging device indicating a compatible communication device that will communicate with the imaging device
